(19) United States
(12) Patent Application Publication
(10) Pub. No.: US 2005/0157856 A1
(43) Pub. Date: Jul. 21, 2005

(54) Method and apparatus for providing an externalized interface to mobile telemetry devices

(76) Inventor: Laymon Scott Humphries, Clinton, MS (US)

Correspondence Address: MCI, INC;TECHNOLOGY LAW DEPARTMENT, 1133 19TH STREET NW, 10TH FLOOR, WASHINGTON, DC, 20036, US

(21) Appl. No.: 10/966,841

(22) Filed: Oct. 15, 2004

Related U.S. Application Data
(63) Continuation-in-part of application No. 10/759,406, filed on Jan. 16, 2004.

(51) Int. Cl. G06G 7/00; H04M 11/00

(52) U.S. Cl. 379/88.17; 379/88.13

(57) ABSTRACT

An approach is provided for retrieving telemetry data. A gateway receives telemetry data message from a telemetry device associated with a user. The gateway determines location of a data repository (e.g., file server, File Transfer Protocol (FTP) site, etc.) for delivery of the telemetry data message, wherein the location is specified by the user. The gateway forwards the telemetry data message to the data repository at the specified location. The above arrangement has particular application in a fleet and asset management system.

### RELATED APPLICATIONS

This application is a continuation-in-part (CIP) of U.S. patent application filed Jan. 16, 2004 (Ser. No. 10/759,406; Attorney Docket: SKY-03-006), entitled “Method and System for Scheduling of Data Retrieval from Mobile Telemetry Devices”; the entirety of which is incorporated herein by reference.

### FIELD OF THE INVENTION

The present invention relates to data communications, and more particularly, to tracking mobile telemetry devices for fleet and asset management.

### BACKGROUND OF THE INVENTION

Modern wireless networks, such as paging systems, can readily be configured to offer a variety of telemetry services, notably fleet and asset management services. The management of vehicles within a fleet as well as assets involves obtaining information, generally in real-time, about the location and movement of these objects. The fleet manager utilizes this information to maximize use of fleet resources. With the advent of the Global Positioning System (GPS) supported by a constellation of satellites, a vehicle may determine its location with great accuracy and convenience if a sufficiently unobstructed radio path exists between the GPS receiver within the vehicle and the satellites. Additionally, the infrastructure investment by service providers to implement a fleet and asset management system is significant. Consequently, such service providers are continually seeking new and enhanced services to derive maximal benefit (e.g., profits) from this large investment and to avoid loss or unauthorized use of resources. Therefore, these service providers seek to offer an efficient, cost-effective fleet and asset management service with robust capability by effectively integrating GPS technology with wireless networks as to minimize bandwidth in the exchange of telemetry data.

FIG. 14 shows a diagram of a conventional wireless network in an autonomous GPS environment. As shown, a wireless network 1401 communicates with vehicles 1403 to track the location of these vehicles 1403 within the coverage area of the wireless network 1401. Each of the vehicles 1403 employ a GPS device 1405 that communicates with a constellation of satellites 1407. These satellites 1407 transmit very low power interference and jamming resistant signals, which are received by the GPS receivers 1405. At any point on Earth, a GPS device 1405 is generally able to receive signals from multiple satellites (e.g., 6 to 11), assuming there are no obstructions.

Specifically, a GPS device 1405 may determine three-dimensional geolocation from signals obtained from at least four satellites. Measurements from satellite tracking and monitoring stations located around the world are incorporated into orbital models for each satellite to compute precise orbital (ephemeris) or clock data. GPS signals are transmitted over two spread spectrum microwave carrier signals that are shared by all of the GPS satellites 1407. The device 1405 must be able to identify the signals from at least four satellites 1407, decode the ephemeris and clock data, determine the pseudo range for each satellite 1407, and compute the position of the receiving antenna. The time required to acquire a position depends on several factors including the number of receiving channels, processing power of the receiving device, and strength of the satellite signals.

The above arrangement, as an autonomous GPS environment, has a number of drawbacks that can hinder its effectiveness as a fleet management system. Because the GPS device 1405 must obtain all of the ephemeris data from the satellite signals, weak signals can be problematic. A building location or a location in any area that does not have clear view of the satellite constellation 1407 can prevent the GPS device 1405 from determining its geolocation. Also, cold start acquisition may consume a few seconds to as much as a few minutes, which is a significant delay for the device's ability to log positional information and evaluate its position against pre-configured alert conditions.

The vehicles 1403 then need to transmit the location information to the wireless network 1401. These transmissions can consume large amounts of bandwidth of the wireless network 1401 if the location information is continually transmitted without attention to the polling scheme and the underlying transmission protocol used to transport such data.

Additionally, conventional systems provide limited control by the user of how the data is provided. This inflexibility does not permit the user to customize the information to particular applications, or to customize the manner in which information is presented, potentially impeding integration with other data processing systems.

Therefore, there is a need for a fleet and asset management system that effectively integrates GPS technology to ensure timely acquisition of location information. There is also a need for users to have the capability to personalize the manner and type of data received from the telemetry devices. There is further a need to efficiently utilize precious resources of the wireless network in support of fleet and asset management services.

### SUMMARY OF THE INVENTION

These and other needs are addressed by the present invention, in which an approach for acquiring data from a mobile telemetry device over a two-way wireless network (e.g., paging system) is provided. Within a fleet and asset management system, a gateway supports an interface whereby a user (or subscriber) can transmit configuration information to the telemetry device for specifying the manner in which telemetry data is generated from the mobile telemetry device, as well as the location of a data repository (e.g., file server, File Transfer Protocol (FTP) site, etc.) where such data is to be forwarded, when received from the telemetry device. The interface utilizes, in an exemplary embodiment, an eXtensible Markup Language (XML) based protocol for the telemetry data retrieval. Although the telemetry device is capable of autonomously obtaining GPS data from GPS satellites under favorable conditions, the fleet and asset management system can supply Assisted-Global Positioning System (A-GPS) data to the telemetry device when needed. The above arrangement advantageously provides flexibility and increased functionality for tracking telemetry devices in support of fleet and asset management.

According to one aspect of the present invention, a method for providing telemetry data is disclosed. The method includes receiving a telemetry data message from a telemetry device associated with a user. The method also includes determining location of a data repository for delivery of the telemetry data message, wherein the location is specified by the user. Further, the method includes forwarding the telemetry data message to the data repository at the specified location.

According to another aspect of the present invention, an apparatus for providing telemetry data is disclosed. The apparatus includes a communication interface configured to receive a telemetry data message from a telemetry device associated with a user. Additionally, the apparatus includes a processor coupled to the communication interface and configured to determine location of a data repository for delivery of the telemetry data message, wherein the location is specified by the user. The telemetry data message is forwarded to the data repository at the specified location.

According to another aspect of the present invention, a computer-readable medium carrying one or more sequences of one or more instructions for providing telemetry data is disclosed. The one or more sequences of one or more instructions including instructions which, when executed by one or more processors, cause the one or more processors to perform the steps of receiving a telemetry data message from a telemetry device associated with a user; and determining location of a data repository for delivery of the telemetry data message, wherein the location is specified by the user. A further step includes forwarding the telemetry data message to the data repository at the specified location.

According to yet another aspect of the present invention, a method for providing a telemetry data from a remote telemetry device to a user is disclosed. The method includes receiving a first telemetry data message from the remote telemetry device. The method also includes determining location of a file server maintained by the user as being a destination for data from the remote telemetry device. Further, the method includes deriving a second telemetry data message from the first telemetry data message; and sending the second telemetry data message to the file server location.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a fleet and asset tracking system, according to an embodiment of the present invention;

FIG. 2 is a diagram of a telemetry device used in the system of FIG. 1, according to an embodiment of the present invention;

FIG. 3 is a diagram of a Network Operations Center (NOC) in the system of FIG. 1, according to an embodiment of the present invention;

FIG. 4 is a diagram of a Wireless Protocol (WP) interface used in the system of FIG. 1;

FIG. 5 is a flowchart of a process for directing transmission of telemetry data, according to an embodiment of the present invention;

FIG. 6 is a flowchart of a process for configuring a remote telemetry device, according to an embodiment of the present invention;

FIG. 7 is a diagram of the formats of protocol messages used in the system of FIG. 1;

FIG. 8 is a diagram of the format of a Wireless Protocol (WP) message used in the system of FIG. 1;

FIG. 9 is a diagram of the format of a batched Wireless Protocol (WP) message used in the system of FIG. 1;

FIG. 10 is a diagram of the telemetry device of FIG. 2 deployed within a vehicle, according to an embodiment of the present invention;

FIG. 11 is a sequence diagram showing a process for retrieving data from a telemetry device based upon a schedule, according to an embodiment of the present invention;

FIG. 12a is a diagram of the formats of data logging messages used in the system of FIG. 1 for instructing the telemetry devices to collect certain data;

FIG. 12b is a diagram of the format of a scheduled read configuration request message used in the system of FIG. 1 for retrieving data from the telemetry devices;

FIGS. 12c and 12d are diagrams of the format of a data message used in the system of FIG. 1;

FIG. 13 is a diagram of a computer system that can be used to implement an embodiment of the present invention; and

FIG. 14 is a diagram of a conventional wireless network in an autonomous GPS environment.

### DESCRIPTION OF THE PREFERRED EMBODIMENT

An apparatus, method, and software for providing telemetry data in support of fleet and asset management are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

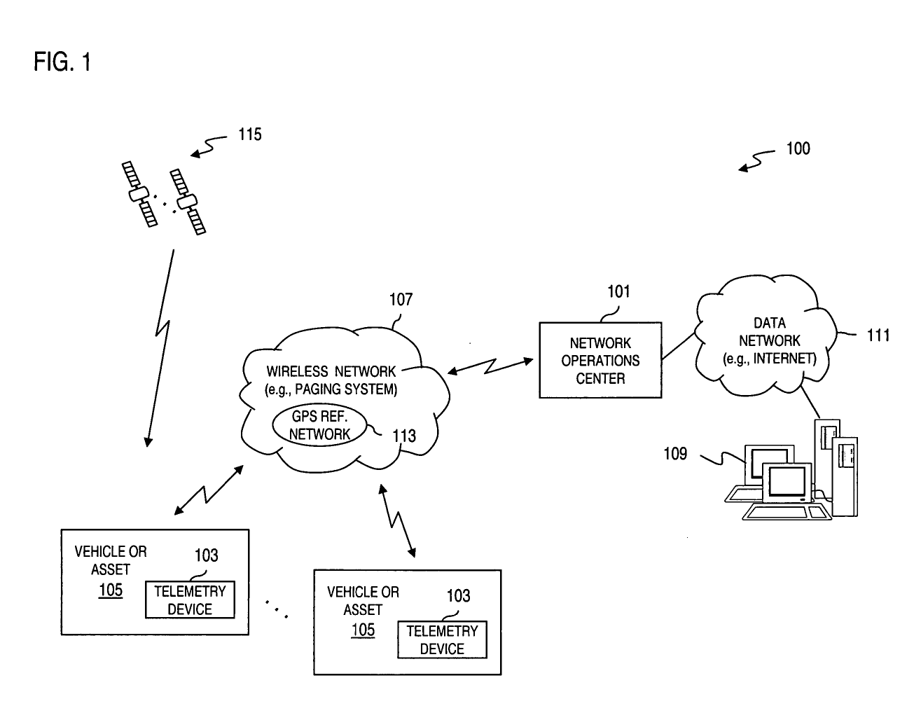

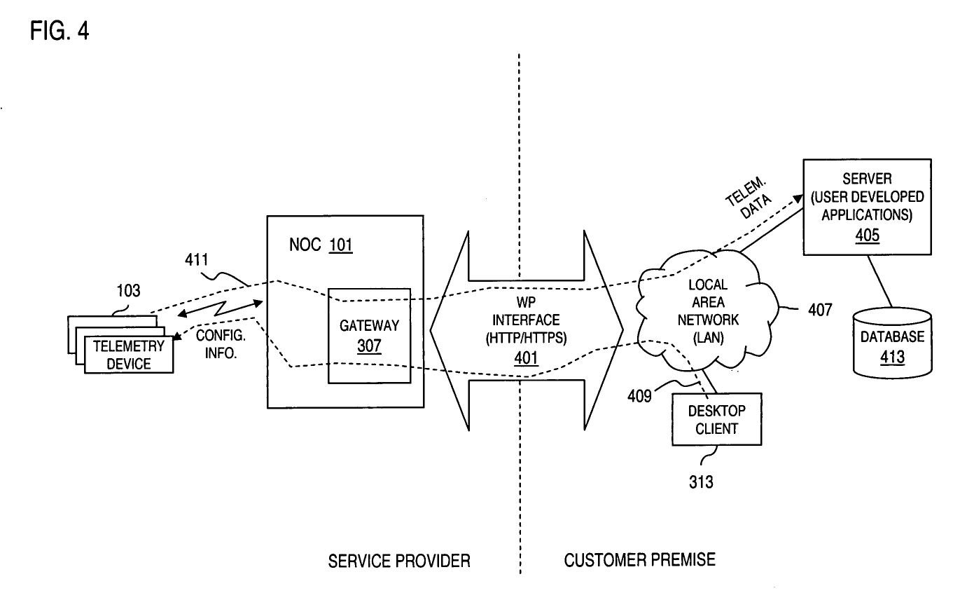

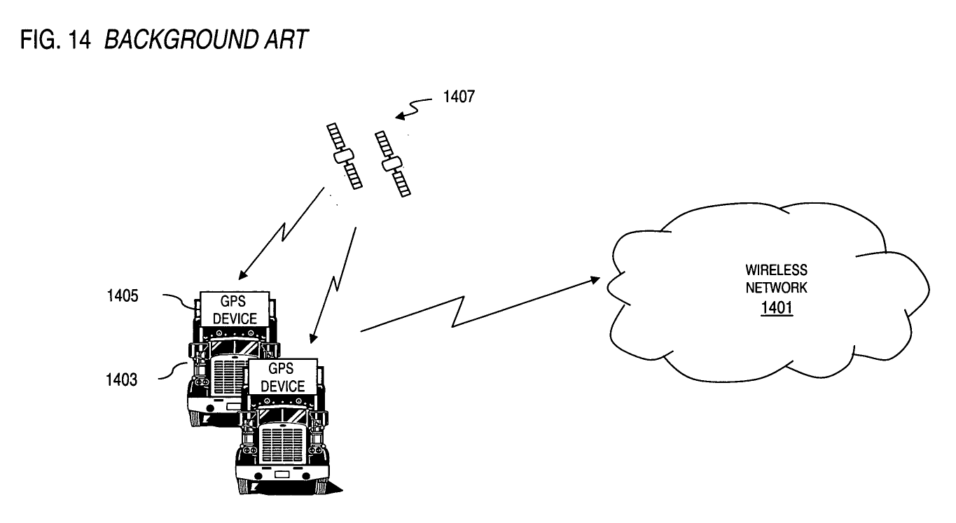

FIG. 1 shows a diagram of a fleet and asset tracking system, according to an embodiment of the present invention. The system 100, in contrast to the system of FIG. 14, utilizes a combination of autonomous GPS and Assisted GPS (A-GPS); in particular, mobile-centric A-GPS. The system 100 includes a Network Operation Center (NOC) 101 for tracking telemetry devices 103, which, under this scenario, are resident within vehicles 105. It is contemplated that the telemetry device 103 can be affixed to an asset (or any other object). The system 100 supports an interface to a user (or customer) to configure the telemetry devices 103, and to direct telemetry data from these devices 103 to a server or data repository as specified by the user. This capability is more fully described with respect to FIGS. 4-6.

A wireless network 107 supports two-way communication among the telemetry devices 103 and the NOC 101; the wireless network 107, in an exemplary embodiment, is a two-way paging system employing the ReFLEX™ protocol by Motorola for two-way advanced messaging. The telemetry devices 103 have two modes of operation: autonomous GPS mode, and A-GPS mode. When operating in A-GPS mode, the system 100 can provide for better in-building or obstructed-view geolocation within a paging system zone. When out of network coverage, the autonomous GPS may be used to obtain geolocation data that may be stored on the device for later transmission.

According to one embodiment of the present invention, the wireless network 107 provides over the air encrypted messages.

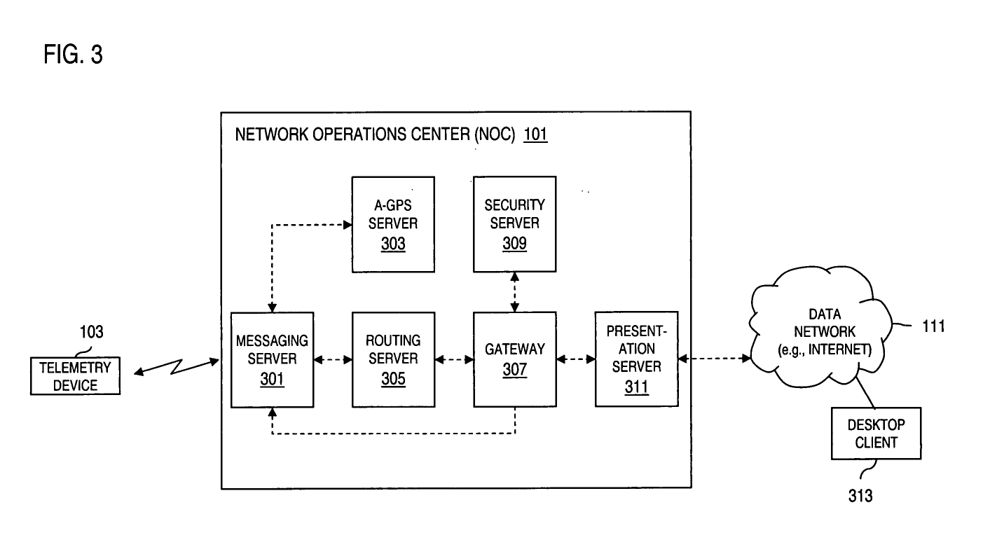

The NOC 101 provides the necessary fleet and asset management functions, such as user account creation and management, access control, and deployment of business rules; these functions are more fully described below with respect to FIG. 3. The NOC 101 also supports remote management capabilities by hosts 109 over a data network 111, such as the global Internet.

To better understand the hybrid A-GPS environment of the system 100, it is instructive to describe the operation of the general operation of a mobile-centric A-GPS system. The telemetry device 103 has GPS hardware and intelligence, whereby the network 107 in conjunction with the NOC 101 employs mechanisms for providing GPS aiding data (or assistance data). The network 107 includes base transmitters and some base receivers containing GPS hardware from which the ephemeris and approximate location can be obtained, constituting a GPS reference network 113.

The assistance data that is transmitted to the devices 103, in an exemplary embodiment, can include ephemeris data differential GPS correct data, timing data and/or other aiding data. Using the aiding (or assistance) data, the telemetry devices 103 performs geolocation calculations, yielding a number of advantages. For example, the telemetry devices 103 can generate real-time speed and route adherence alerts. Additionally, transmission of geolocation data need not be frequent. Transmission of geolocation data is more compact because it is true location rather than pseudo range data. Also, the telemetry devices 103 can more intelligently request assistance data because the devices 103 themselves can determine when the ephemeris data is no longer valid.

The hybrid A-GPS system 100 thus permits fast and precise geolocation when in network coverage of the network 101, while providing immunity from obstructed view of the sky. Also, when the switch is made to autonomous GPS mode (when outside of the coverage area of the network 101), the devices 103 can still obtain geolocation data. This data can be stored within the device 103 and transmitted to the NOC 101 when the associated vehicle 105 returns to the network coverage area.

As noted earlier, the telemetry devices 103 may be attached to a host entity such as a vehicle or other valuable asset. The device may be used to track, monitor, and control aspects of the host entity. These devices 103 are configurable with respect to the existence and number of digital inputs/outputs (I/O), analog inputs/outputs (I/O), and device port interfaces for connection with peripheral devices. By way of example, the digital inputs can be used to monitor various components of the vehicles 105: ignition status, door lock status, generic switch status, headlight status, and seat occupancy status. The digital outputs can be used to control, for instance, the starter, and door locks, and to monitor such parameters as engine temperature, cargo temperature, oil pressure, fuel level, ambient temperature, and battery voltage. The exact configuration of the telemetry devices 103 can be based on cost consideration and/or applications.

The telemetry devices 103, in an exemplary embodiment, employ a wireless protocol to receive commands and transmit data and alerts (e.g., high speed alert) over the radio network 107. The telemetry devices 103 can queue alerts, message responses, and scheduled data, whereby if the devices 103 are unable to send the messages, the messages are queued and sent when the device 103 returns to wireless network coverage. Prioritized queues are used and include, for example, queues for high, normal, and low priority messages. In the exemplary implementation, critical device status changes are given highest priority, while other alerts and responses are given normal priority. Scheduled data messages are given the lowest priority. The queues are configured, as first in yields first out, wherein new messages are dropped when its corresponding queue is full. This arrangement advantageously allows for the status of the device 103 at the time of transmission failure to be known even when the data stored in the data log at time of the transmission has been overwritten.

The telemetry devices 103 can also respond to status (e.g., of position, speed, digital I/O port status, analog input channel status, peripheral status or other device status) queries transmitted by the NOC 101. The status query may request either current status or status within a time and date range. The device 103 responds to the query with either the current status or all status within the date and time range that is currently stored in the device's data log.

As regards data logging, the devices 103 support use of one or more schedules for the data acquisition. The data logging involves storing of the data locally on the device 103. This data, which can include position, speed, digital I/O port status, analog input channel status, peripheral status or other device status, is not continually transmitted over the air. Instead, the data is stored for a finite period of time and made available for use by scheduled data acquisitions, data acquisitions on demand, and data acquisitions associated with alerts. The data log is circular in that when the last available memory for the data logger has been written, the data logger begins recording new data at the first location of memory available for the data logger.

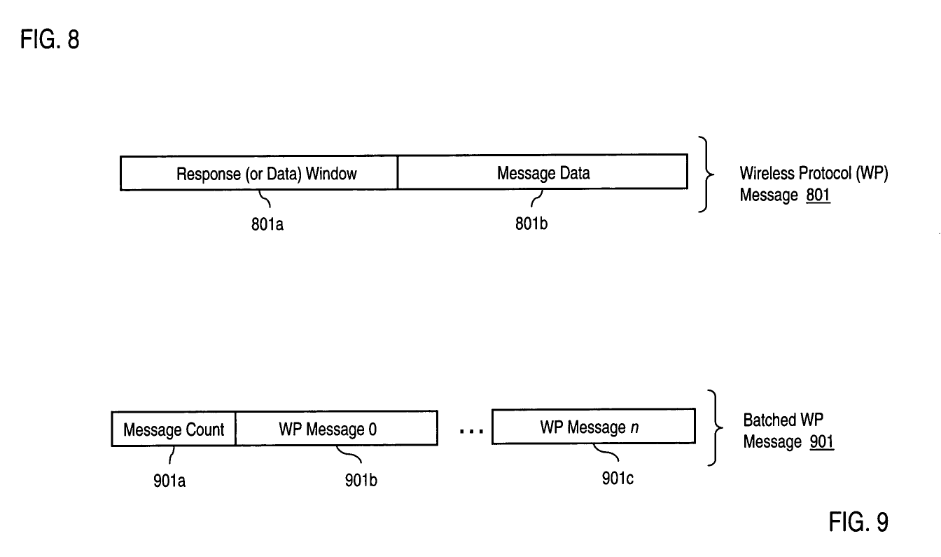

With scheduled acquisitions of the data collected by the data logger, the data within the data log is transmitted by the device 103 according to a configurable schedule at the configured transmission rate. Multiple schedules may be configured on the device 103. Schedules are configured to obtain data at a regular interval based upon calendar time and date. Schedules may be configured such that they are enabled and disabled based upon status of a digital input. For example, an ignition status input may be used to activate a schedule when the engine is on and to deactivate the schedule when the engine is off. A Response (or Data) Message Window value can be configured on the device 103, such that the device 103 delays sending scheduled data using an Offset within the Data Message Window (shown in FIG. 8). That is, the scheduled transmit time is adjusted by the Offset, the device 103 delays queuing the scheduled data until the time is equal to the transmit time plus the Offset. Use of the Data Message Window helps prevent overwhelming the wireless network when many devices are scheduled to transmit data at the same time. For example, it is likely that many schedules will be based upon transmitting on the hour, half past the hour, or at fifteen minute intervals. Using the Offset ensures that the scheduled data transmissions from all of the devices with similar schedules are not sent at precisely the same time. Given the precision of the telemetry device's clock (as it is based upon GPS time), this staggering of regularly scheduled device transmissions is particularly useful.

As mentioned previously, the telemetry devices 103 can be configured to monitor a variety of information relating to the vehicle or asset through the digital I/O and analog I/O. For instance, alerts can be used to indicate status change of the digital inputs. Each Digital Input Status Change Alert can be enabled and disabled through configuration. The alert may be configured to transmit other device status recorded at the time of the alert such as position, speed, status of other digital I/O ports, analog input status, peripheral status, or other device status. As regards the digital output, the status of each available digital output can be changed or read.

Similarly, the statuses of analog inputs of the devices 103 are monitored for change. In an exemplary embodiment, multiple threshold levels (e.g., high and low) can be set, whereby alerts are generated (e.g., Low Range Entry alert, Low Range Exit, High Range Entry, and High Range Exit). That is, if the value of the Analog Input falls below the Low Threshold, a Low Range Entry Alert is generated. If the value of the Analog Input rises above the Low Threshold plus a Hysteresis is value, a Low Range Exit Alert is generated. In similar fashion, if the value of the Analog Input rises above the High Threshold, a High Range Entry Alert is output from the device 103. Also, if the value of the Analog Input falls below the High Threshold minus a Hysteresis value, a High Range Exit Alert is generated. The alert may be configured to transmit other device status recorded at the time of the alert such as position, speed, status of other digital I/O ports, analog input status, peripheral status, or other device status.

By way of example, the devices 103 can be used to monitor excessive speed via a High Speed Alert Control, whereby a High Speed Threshold can be set by a fleet manager. In addition, a duration parameter (i.e., High Speed Duration) can be utilized to specify the time at which the High Speed Threshold must be exceeded before an alert is generated. Further, a configurable High Speed Hysteresis parameter is set as the delta change below the High Speed Threshold used to determine when the High Speed Threshold has no longer been exceeded. The alert may be configured to transmit other device status recorded at the time of the alert such as position, speed, status of other digital I/O ports, analog input status, peripheral status, or other device status.

The system 100 also permits users via the hosts 109 to specify and configure areas of interest within the coverage area of the network 101 such that alerts can be generated when a device 103 enters or exits the configured areas. The alert may be configured to transmit other device status recorded at the time of the alert such as position, speed, status of other digital I/O ports, analog input status, peripheral status, or other device status.

The data collected and transmitted by the telemetry devices 103 are processed by the NOC 101, whose components are described with respect to FIG. 3.

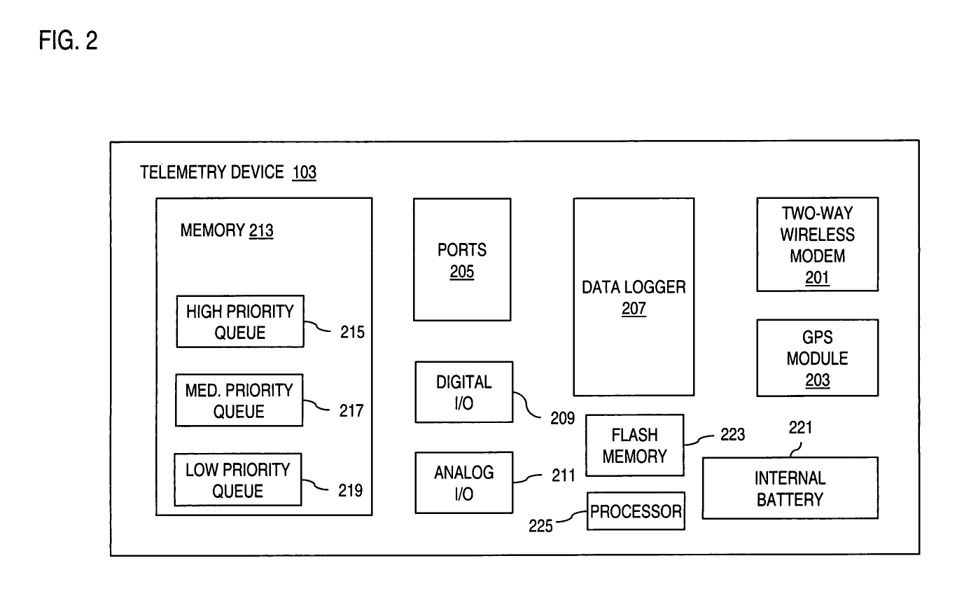

FIG. 2 shows a diagram of a telemetry device used in the system of FIG. 1, according to an embodiment of the present invention. The telemetry device 103, which can be deployed within a vehicle (as shown in FIG. 1 or coupled to any asset), operates within the wireless network 107. By way of example, the components of the telemetry device 103 are described in the context of a narrowband network, such as a paging system; however, it is contemplated that the components for communications can be tailored to the specific wireless network.

In this exemplary embodiment, the telemetry device 103 includes a two-way wireless modem 201 for receiving and transmitting signals over the wireless network 107 according to the communication protocols supported by the wireless network 107, such as the Motorola ReFLEX™ protocol for two-way paging. By way of example, a Karli REFLEX™ module by Advantra International can be used for the modem 201. The two-way wireless modem 201 couples to a two-way wireless antenna (not shown) that can be placed local to the device 103 or remote from the device 103 (e.g., 12 or more feet) to enhance flexibility in installation.

The telemetry device 103 also contains a GPS module 203 that is capable of operating in the multiple GPS modes: autonomous GPS mode, and mobile-based A-GPS mode. The GPS module 203 can employ, for example, a GPS receiver manufactured by FastraX-iTrax02/4. In autonomous mode, GPS data may be acquired with no assistance data provided by the wireless network 107. The GPS module 203 operates in the A-GPS mode when the device 103 is in wireless network coverage, in which assistance data is supplied and can include ephemeris data and data to obtain location in obstructed view locations (in building, wooded areas, etc.). Further, the assistance can include differential GPS (DGPS) to enhance location accuracy under some conditions. The GPS module 203 couples to a GPS antenna (not shown) that can be placed local to the device 103 or remote from the device 103 (e.g., 12 or more feet) to enhance flexibility in installation.

Attachment of peripheral modules to the telemetry device 103 are supported by one or more peripheral ports 205. The ports 205, for example, can be used to connect to intelligent peripherals that operate according to business rules and logic. These business rules and logic can be housed in a vehicle harness (not shown), which include an On-Board Diagnostic (OBDII) interface and intelligence. Under this arrangement, a user (e.g., fleet manager) can query any parameter available through the OBDII interface. For example, data obtained for each tracking record can include any combination of the following items: RPM (Revolutions Per Minute), oil pressure, coolant temperature, etc. Such data recorded by the telemetry device 103 is stored in memory 213. The acquisition period for the data is configurable, as well as the transmission interval to the NOC 101. Furthermore, the monitoring and subsequent data exchange can be governed by a configurable schedule, which can specify such parameters as start date, start time, end time, recurrence (e.g., daily, weekly, monthly, etc.), and duration.

Data is logged by a data logger 207, made available for use by scheduled data acquisitions, data acquisitions on demand, and data acquisitions associated with alerts. As mentioned, the telemetry device 103 also can be configured to include digital I/O 209 and analog I/O 211 for monitoring and control of the vehicle or asset. The data logger 207 also collects data associated with these I/O ports 209, 211.

The telemetry device 103 also includes a processor 225 that may handle arithmetic computations, and may support operating system and application processing. The processor 225, while shown as a single block, may be configured as multiple processors, any of which may support multipurpose processing, or which may support a single function.

The memory 213 of the telemetry device 103 can be organized to include multiple queues for prioritizing the messages to be processed by the device 103. In an exemplary embodiment, the memory 213 includes a High Priority queue 215, a Medium Priority queue 217, and Low Priority queue 219. The memory 213, while shown as a single block, may be configured as multiple memory devices, any of which may support static or dynamic storage, and may include code for operating system functionality, microcode, or application code.

Data recorded by the telemetry device 103 may additionally be stored in a storage medium other than the prioritized queues 215, 217, and 219, such as in a flash memory 223. A log (not shown) of information may be kept so that the information may be transmitted according to a schedule, as discussed above, or, e.g., upon receipt of a request to send all data that has been collected. Storage devices have only a finite amount of space for storage of information, and thus the information for only a finite number of messages may be stored in either the prioritized queues 215, 217, 219 or the flash memory 223.

To improve availability of the telemetry device 103, an internal battery 221 is optionally included. With the internal battery, the telemetry device 103 can continue to monitor and transmit alerts and status information to the NOC 101 even if the electrical system of a vehicle is inoperable. Additionally, the internal battery 221 can be used by the device 103 to report power status wirelessly and to shut down gracefully when the energy level of the internal battery is becoming too low to sustain operation of the device.

The functions of the NOC 101, which interacts with the telemetry devices 103 to exchange information for supporting fleet and asset management, are detailed with respect to FIG. 3.

FIG. 3 shows a diagram of a Network Operations Center (NOC) in the system of FIG. 1, according to an embodiment of the present invention. The NOC 101 utilizes, in this exemplary embodiment, a client-server architecture to support the telemetry devices 103. Specifically, the NOC 101 houses a messaging server 301 for sending and receiving messages to the devices 103 over the air, for storing the messages, and routing these messages to their destination. The NOC 101 provides connectivity via a local area network (LAN) (not shown) for the messaging server 103 with an A-GPS server 303, a routing server 305, and a gateway 307. The gateway 307 communicates with a security server 309 to support encryption and decryption of the messages. A presentation server 311 resides within the NOC 101 to interface with the data network 111 (e.g., the global Internet), such that the host 109 can access the services of the fleet and asset management system. The host 109 under this scenario is loaded with a desktop client 313.

Although a single server is shown for the presentation server 311, in the alternative, the server 311 can functionally be implemented as three separate servers: a database server, a middleware server, and a web server. The database server is responsible for data storing, data updating, and data retrieval as well as providing a set of interfaces to achieve these functions. The web server is responsible for serving maps, presenting user interfaces to manage and control user administration, device configuration, and etc. The middleware server can be deployed between the database server and the web server, and has the following responsibilities: 1) converting the web server's data retrieval requests to database server APIs and then sending to database server, 2) receiving the responses from the database server and then sending back to web server, and 3) receiving data from gateway 307 and then sending requests to the database to store/update data records. Because of the modularity in this design, these three components can reside on the same machine, as shown in FIG. 3, or reside in multiple platforms.

Messages from the telemetry devices 103 are forwarded by the messaging server 301 to either the A-GPS server 303 or the routing server 305. If the message is an assist request, this message is sent to the A-GPS server 303. In response to the GPS assist request, the A-GPS server 303 determines GPS assistance data for transmission to the requesting telemetry device 103.

The A-GPS server 303 obtains ephemeris data from the GPS reference network 113, and determines satellite configuration for each of the geographic zones comprising the wireless network. The A-GPS server 303 also determines the assistance data for each geographic zone. The NOC 101 then periodically broadcasts the assistance data to each geographic zone. In addition, the A-GPS server 303 supplies GPS assistance data to any telemetry device 103 that requests the GPS assistance data. When supporting this request, the NOC 101 determines approximate location of the requesting device 103 (based upon base receivers that received the request, using a type of triangulation. Subsequently, a GPS Assistance message is generated by the A-GPS server 303 to send to the telemetry device 303 based upon its approximate location. The messaging server 301 sends the GPS Assistance message to the particular telemetry device 103.

Thus, the A-GPS server 303 delivers GPS assistance data through two mechanisms by periodically broadcasting GPS assistance data to all devices 103 in each of the geographic zones covered by the wireless network 107, or by responding to specific requests by the telemetry devices 103 for GPS assistance data.

The routing server 305 has responsibility for routing of the messages from the telemetry devices 103, and managing such messages from the devices 103 to their server destinations. Each device 103 can be configured to have messages directed to one or more destination servers. The routing server 305, upon receiving message from a telemetry device 103, determines a destination address that has been configured for the device 103 and modifies the destination address accordingly. The message is then forwarded to the configured destination. By default, the messages are directed to the gateway 307.

The gateway 307 interfaces with the presentation server 311 to permit the desktop client 313 access to the fleet and asset management system. The gateway 307 provides translation of wireline messages and commands from the presentation server 311 to the wireless protocol for communication with the telemetry devices 103. For example, the gateway 307 supports an extensible Markup Language (XML) interface, such that XML commands submitted to the gateway 307 over wireline are converted to the wireless protocol commands and sent over the paging network 107 to the devices 103. In turn, the wireless protocol messages received from the devices 103 are converted to wireline XML messages. The gateway 307 provides translation of wireline messages and commands from the host 109 to the wireless protocol for communication with the telemetry devices 103. In turn, the wireless protocol messages received from the devices 103 are converted to wireline XML messages and sent to host 109.

The presentation server 311 provides the following functions: fleet and asset tracking, and general purpose I/O monitoring and control. The server 311 also maintains a database (not shown) for user accounts and other related data (e.g., configuration data, user management information, device management, and data acquired from the devices 103). The presentation server 311, as mentioned, also generates the maps corresponding to where the devices 103 are tracked and the mapping preferences configured. Using the desktop client 313, a user can even issue requests to command a particular device 103, such as requesting location of the device 103.

With the presentation server 311 as a front end, a user via the desktop client 313 can configure the telemetry devices 103 via web interfaces. In an exemplary embodiment, the server 311 is a World Wide Web (“web”) application server to support a web browser based front-end for the desktop clients 109. The web application server (not shown) can be deployed to support such web interfaces as a set of Java Server Pages (JSP) and Java Applet to interact with the user on the desktop client 313. On the backend, based on data collected by JSP and Java Applet, the web server can generate the proper XML commands that are compliant with Application Programming Interface (API) of the presentation server 311. Consequently, the collected records can be stored in the database of the presentation server 311. The database also stores the properties of the telemetry devices 103, such as the alerts and thresholds earlier described.

The desktop client 313 interfaces to the system 100 through the presentation server 311. From the desktop client 313, the user logs in to the system 100. The presentation server 311 can also perform authentication as well as administration tasks such as adding new users or devices 103. The user can also configure business rules executed by the presentation server 311, wherein the business rules logic uses this user supplied configuration to configure the devices 103, acquire, and process data from the devices 103.

Additionally, the presentation server 311 provides a reporting capability based on the stored information in the database. The presentation server 311 can support standard reports or customize reports to the user via the desktop client 313.

Instead of using a desktop client 313, the user, if associated with a large organization, can utilize an enterprise server to obtain all of the user functionality through the gateway 307 using the API of the fleet and asset management system 100. Accordingly, the enterprise server would possess the functional capabilities of the presentation server 311, but would be managed by the customer (or user) at the customer's premise, as shown in FIG. 4. By way of example, the server 405 can execute user developed applications.

As noted, the wireless protocol supports communications between the NOC 101 and the telemetry devices 103. In an exemplary embodiment, the messaging is performed according the FLEXsuite Uniform Addressing & Routing (UAR) protocol (developed by Motorola). The wireless protocol message, which can be encapsulated with an UAR message, is unencrypted.

FIG. 4 is a diagram of a Wireless Protocol (WP) interface used in the system of FIG. 1. Communication between the service provider and a customer (e.g., an enterprise) is facilitated by a WP interface 401, which, in an exemplary embodiment, support HyperText Transfer Protocol (HTTP) or HTTPS (HTTP Secure) sessions. The WP interface 401 represents an externalized interface to permit customers a standardized mechanism for sending commands and receiving data from any authorized telemetry device 103; externalized in the sense that the interface 401 supports access by systems and hosts external to the service provider's system.

The WP interface 401, an exemplary embodiment, employs an eXtensible Markup Language (XML) based protocol. The protocol is used to configure, control, and receive data from the telemetry devices 103. The wireless protocol can also specify whether HTTP or HTTPS is used for transport of the telemetry data. A customer, via the WP interface 401, may send commands to the telemetry device 103 and receive back regularly scheduled data, requested data, and alerts. The gateway 307 can send the commands over the air, for example, in encrypted compact packets to a customer's telemetry device 103. Likewise, the gateway 307 interprets commands received from the customer's device 103 and sends WP XML data to a customer's server (or server farm).

In this example, a user may configure schedules to the telemetry device 103 so that data is obtained on a regular basis. Notably, a user via the desktop client 313 can transmit configuration information to the telemetry device 103 to instruct the device 103 the manner in which the device 103 is to generate the telemetry data and the location (or address) of a file server 405 which is to receive the telemetry data. For example, the configuration information can specify the type of data that is to be collected and forwarded, as well as the frequency of such collection and transmission. This configuration information follows a communication path 409 from the desktop client 313 to the telemetry device 103.

A customer may configure the device 103 through the wireless protocol to send messages from the device 103 to the customer's server 405, which can be specified as a Uniform Resource Locator (URL). The address format used by the wireless protocol depends upon the entity being addressed. For instance, the addressing of the telemetry device 103 can be by a unique serial number. The address format for enterprise hosts uses the following URL format: Protocol://Domain[:Port][/Path]. Once specified, the gateway 307 can push all positional information, I/O data, and alerts to the customer's server 405 via a local area network (LAN) 407. One advantage provided by the wireless protocol is the ability to specify multiple schedules on a single device 103. Alert configurations may also be sent to the device 103, such as digital I/O, analog input, high speed and route adherence alerts.

In turn, the telemetry device 103 submits the telemetry data over a communication path 411. The telemetry data can then be stored in a database 413. Under this scenario, the customer is responsible for maintaining the database 413, which is populated as messages arrive at the server 407. Under this scenario, the server 405 and database 413 constitutes a data repository. This arrangement thus enables the customer to keep the data for as long as needed, and with the appropriate level of security desired.

According to one embodiment of the present invention, the telemetry data received at the gateway 307 is routed as the data arrives, and thus, the wireless protocol need not include commands for polling the database 413.

With the WP interface 401, the customer is provided with functionality to allow for the development of an enterprise solution, affording great flexibility for the customer to meet application requirements.

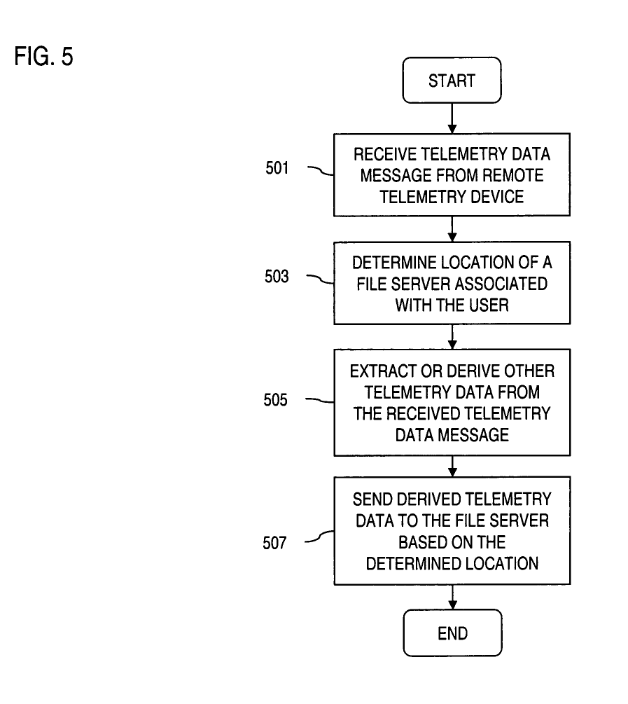

FIG. 5 is a flowchart of a process for directing transmission of telemetry data, according to an embodiment of the present invention. As pointed out, the user (or customer) has the capability to retrieve telemetry data from the telemetry device 103. The system 100 provides a variety of features with respect to this capability, such as directing where the telemetry data should be forwarded. In steps 501 and 503, upon receiving a telemetry data message from the telemetry device 103, the gateway 307 determines the location of a data repository, such as file server (or File Transfer Protocol (FTP) site) associated with the user. This determination can be simply based on information in the telemetry data message, which may explicitly identify the location of the data repository (e.g., the server 405) without further processing or manipulation by the gateway 307. Alternatively, the information can be an identifier that may require mapping and/or further address resolution (e.g., DNS query) to locate the server 405.

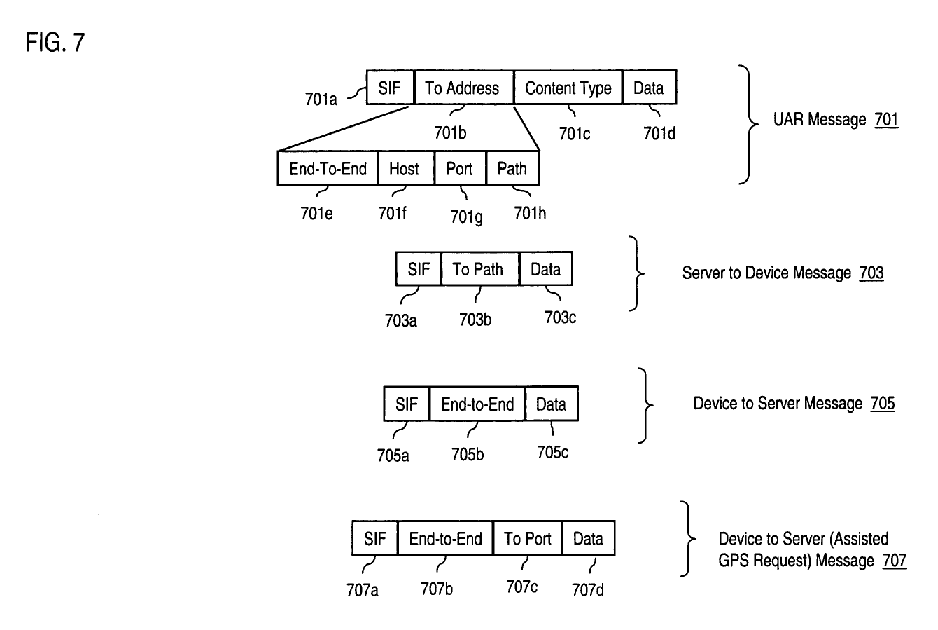

The WP transactions can involve the sending of telemetry data asynchronously from the gateway 307 to the server 405. To enable the completion of these transactions, the telemetry devices 103, according to one embodiment of the present invention, are configured to have messages routed to the server 405, wherein addressing information about the server 405 is stored in the devices 103 themselves. This can be accomplished through submission of a configuration message for configuring a user's device 103 so that data as well as notifications and alerts are routed to the server 405. For example, the desktop client 313 issues a configuration message that specifies the addressing information associated with the server 405. It is contemplated that multiple devices 103 can be configured simultaneously, by specifying the devices 103 in the “To address” field (of FIG. 7, below).

In the alternative, the gateway 307 can store the addressing information, whereby mapping of the particular telemetry device 103 to addressing information associated with the data repository (e.g., a network address) can be based on a unique identifier (e.g., serial number) assigned to the telemetry device 103. The addressing information can be an Internet Protocol (IP) address, a Uniform Resource Locator (URL), or a domain name. When a domain name is utilized, the gateway 307 may need to perform a DNS lookup function for the IP address of the server 405. The mapping by the gateway 307 can be performed, for example, via a lookup table. This arrangement can advantageously simplify the operation of the telemetry devices 103, and thus cost, by tasking the gateway 307 with the mapping function.

Next, the gateway 307 extracts or derives, as in step 505, other telemetry data from the received data message. The telemetry data message, in an exemplary embodiment, includes raw telemetry data. The gateway 307 can either forward the raw telemetry data through extraction or pre-process the raw data by deriving other or new telemetry information. Thereafter, the extracted or derived telemetry data is forwarded to the file server 405 (or a File Transfer Protocol (FTP) site) based on the determined location, per step 507.

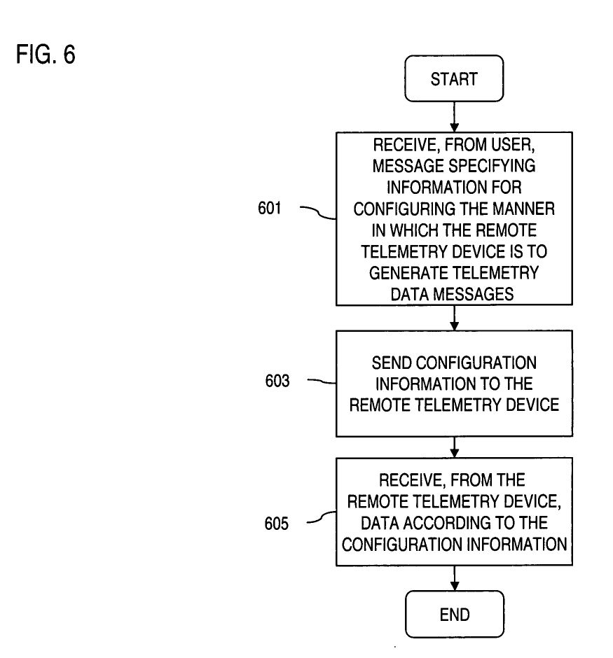

FIG. 6 is a flowchart of a process for configuring a remote telemetry device, according to an embodiment of the present invention. The gateway 307, as in step 601, receives a message specifying information for configuring the manner in which the remote telemetry device 103 is to generate telemetry data messages. That is, the configuration information can specify an attribute of how the telemetry device 103 is to generate telemetry data messages. For instance, the attribute can be set to trigger an autonomous generation of the telemetry data messages. Further, a user can specify the location of the server 405 as part of the configuration information.

In step 603, the gateway 307 sends the configuration information from the desktop client 313 to the particular telemetry device 103. In step 605, the gateway 307 receives, from the telemetry device 103, the telemetry data according to the configuration information. This information, as discussed in the process of FIG. 5, is then forwarded to the location specified by the user, such as the server 405.

FIG. 7 shows a diagram of the formats of protocol messages used in the system of FIG. 1. By way of example, the protocol is the UAR protocol. Accordingly, a UAR message 701 includes the following fields: a Status Information Field (SIF) field 701a, a Destination Address (“To Address”) field 701b, a Content Type field 701c, and a Data field 701d. Table 1, below, defines these fields 701a-701c.

TABLE 1

| Field | Definition | Data Type | Size |
|---|---|---|---|
| SIF | Identifies the application | Integer | 8 bits |
| | protocol used to encode | | |
| | the remaining data in | | |
| | the message; indicates UAR | | |
| | addressing is used | | |
| To | Destination Address | UAR “To | Variable |
| Address | | Address” Encoding | |
| Content | Identifies the format of the | UAR Content | 24 bits |
| Type | attached Data | Type | |
| Data | UAR format data payload | UAR data | Variable |

With respect to the “To Address” field 701b, this address can be further specified the following fields: an End-To-End field 701e, a Host field 701f, a Port field 701g, and a Path field 701h. The End-To-End field 701e is utilized for device to server routing. It is noted that no addressing is needed for device to server routing with the exception of an Assisted GPS Request message. Because the routing server 305 controls message routing from the telemetry device 103, some of the address information requirement is specific to UAR. Path Addressing, per the Path field 701h, is used for server to device routing, as in the case, for example, addressing of a peripheral device attached to the telemetry device 103. As shown in FIG. 7, for server to device messaging, message 703 can be used and includes a SIF field 703a, a To Address field 703b specifying the path, and a Data field 703c. A device to server message 705 utilizes a SIF field 705a, a To Address field 705b specifying the End-to-End address, and a Data field 705c. In the case of a device to server transmission relating to acquisition of Assisted GPS (e.g., in form of an Assisted GPS request), a message 707 is provided, and includes a SIF field 707a, a To Address field specifying the End-to-End address 707b and Port 707c, and a Data field 705c.

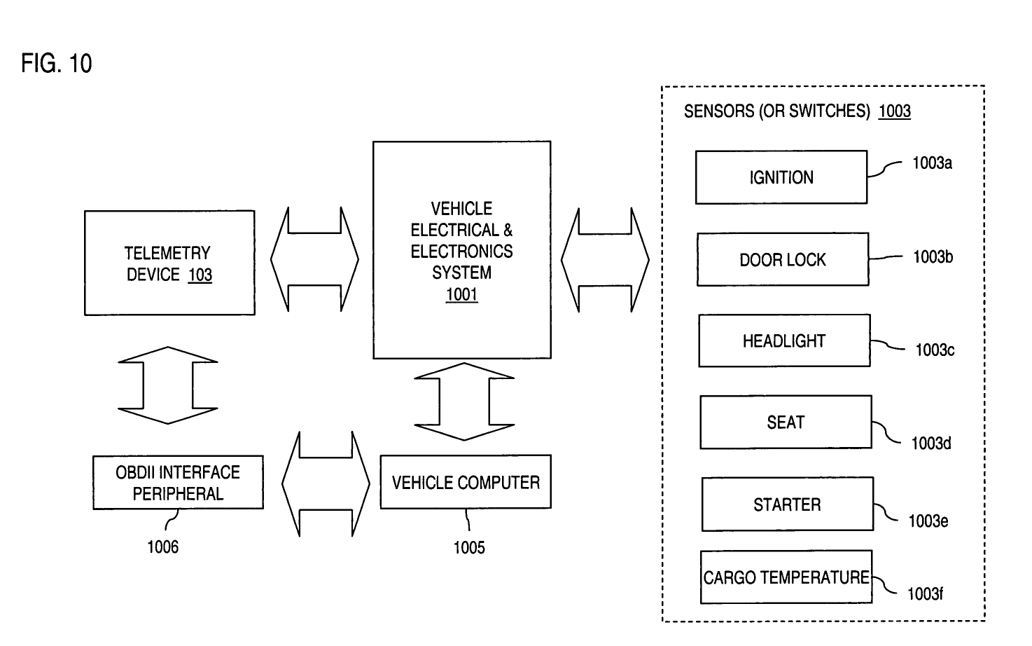

As regards UAR messages in general, the Data field 701d contains binary formatted data, which is the unencrypted Wireless Protocol (WP) message (as described in FIGS. 8 and 9).

FIG. 8 shows a diagram of the format of a Wireless Protocol (WP) message used in the system of FIG. 1. A Wireless Protocol message 801 includes a Response Window (or Data Window) field 801a to regulate the over-to-air transmission of the message from the telemetry device 103 to the NOC 101, as described previously. In other words, with the telemetry devices 103, accommodation is made to support staggering of device responses to prevent overwhelming the reverse path of the wireless network 107 (FIG. 1) if a command is sent to a large number of devices in a broadcast message. The Response Window field 801a is thus used to specify a desired time frame for obtaining responses from deployed devices 103. If a Response Window is specified in a message, the device 103 delays sending its response using an Offset value within the Response Window when responding to the message. That is, after first processing the message, the device 103 delays sending the response to the message until the Offset time has expired. To ensure a good distribution of responses during the Response Window, the device 103, in an exemplary embodiment, can randomly select an Offset time within the specified time window.

The message 801 also provides a Message Data field 801b for specifying the data (such as data within the data log, and alerts). According to one embodiment of the present invention, the NOC 101 can batch the WP messages 801 to reduce overhead, resulting in a batched message 901. The batched message 901 specifies a Message Count field 901a to indicate the number of WP messages 801 (0 . . . n, where n is an integer) that are contained within the batched message 901. The WP Message fields 901b, 901c pertain to the corresponding messages specified by the Message Count value in the field 901a. The messages of FIGS. 8 and 9 support a number of transactions between the NOC 101 and the telemetry device 103. For example, server transactions involve a request being sent from a server (e.g., servers 301, 303, and 305) to the device 103 and a response sent from the device 103 to the server.

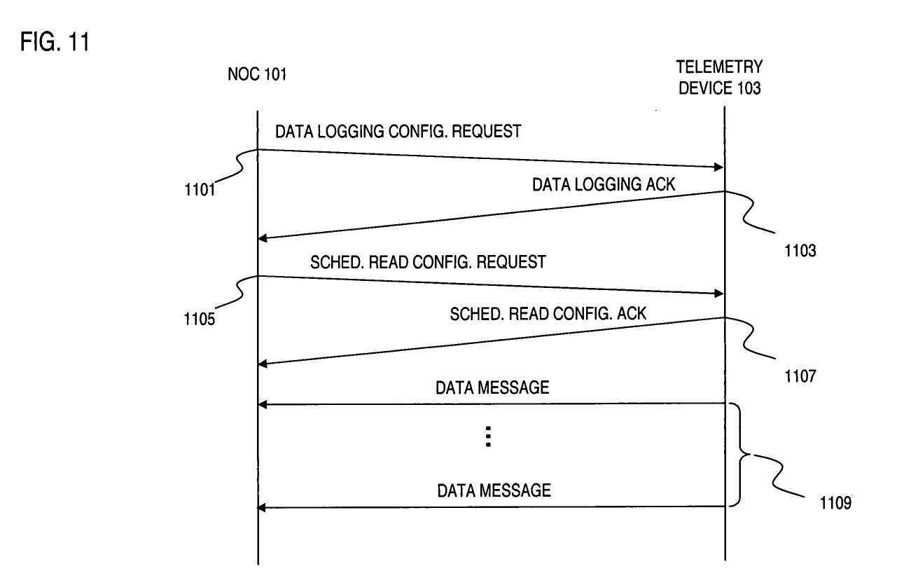

FIG. 10 is a diagram of the telemetry device of FIG. 2 deployed within the vehicle, according to an embodiment of the present invention. In this exemplary scenario, the telemetry device 103 interfaces with a vehicle electrical and electronics system 1001 to obtain data relating to a variety of environmental and diagnostic information. For instance, the vehicle electrical and electronics system 1001 can include electrical sensors (or switches) 1003 deployed through the vehicle. These sensors 1003 can relay information regarding status of the following: ignition 1003a, door lock 1003b, headlight 1003c, seat occupancy 1003d, starter 1003e, and cargo temperature 1003f. Also, the system 1001 can interface to the vehicle computer 1005 through an OBDII (On board Diagnostics) interface peripheral 1006. The vehicle computer 1005 records information regarding, for example, speed, average speed, distance traveled, fuel level, fuel economy, distance to empty fuel tank, RPM, coolant temperature and level, oil pressure, alternator and brakes, battery voltage, windshield washer fluid level, ambient temperature, cargo temperature, and outside temperature. The data relating to the system 1001 is collected by the telemetry device 103 within its data log and made available to the NOC 101.

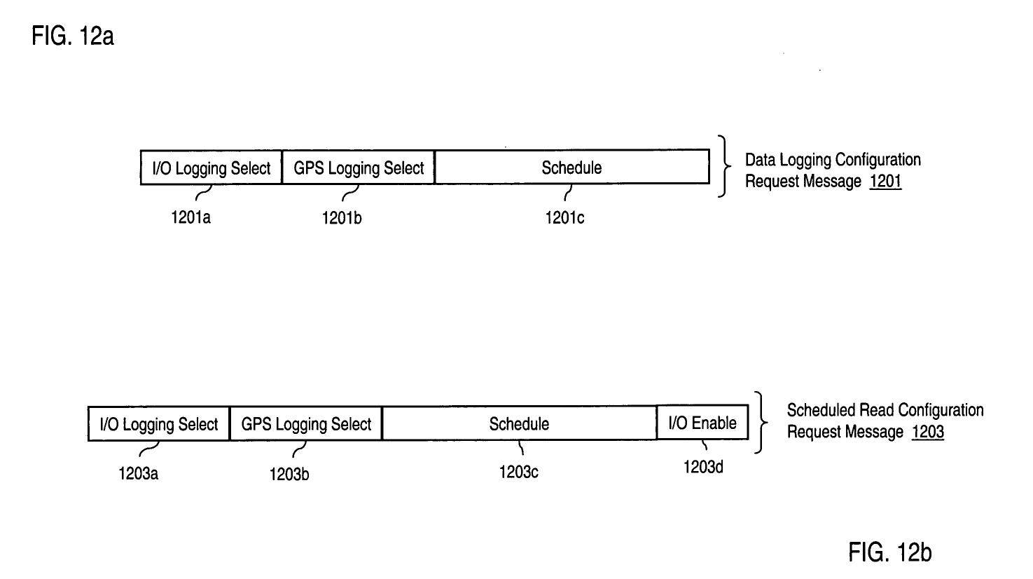

This process of data collection and subsequent transmission to the NOC 101 can be triggered according a configurable schedule and is explained below in FIG. 11. Moreover, the schedule can be activated or deactivated based upon status of an input/output 209, 211, such as ignition On/Off state.

Although the above discussion involves the telemetry device 103 collecting data in an automotive context, it is recognized that data relating to any asset can be gathered.

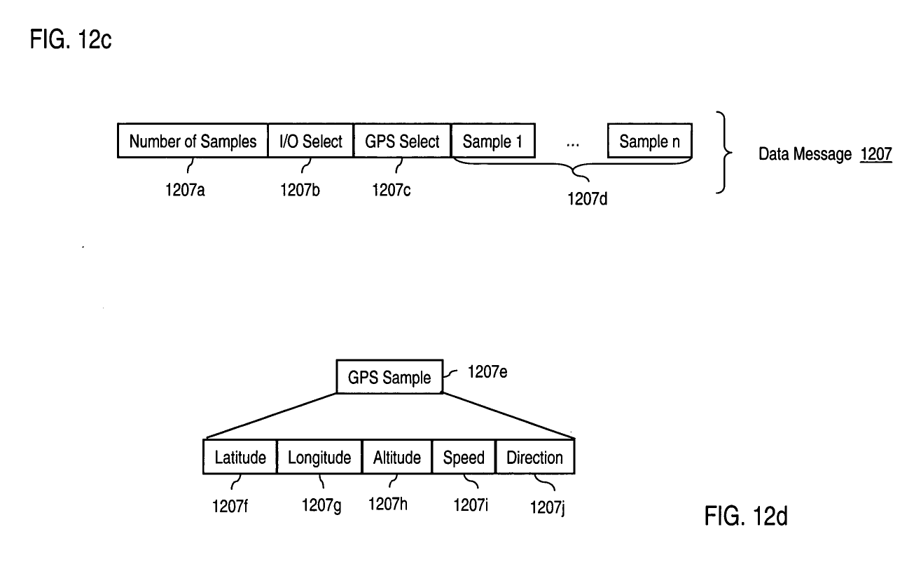

FIG. 11 is a sequence diagram showing a process for retrieving data from a telemetry device based upon a schedule, according to an embodiment of the present invention. The NOC 101 has the capability to control the data that is collected by the telemetry device 103 through submission of a data logging configuration request message, per step 1101. This request message, as will be further detailed in FIG. 12a, includes fields for specifying the device inputs and outputs that are to be monitored as well as polling period information for the data collection. Upon receipt of this request, the telemetry device 103 acknowledges, as in step 1103, with a data logging acknowledge message.

Thereafter, to retrieve the data stored in the data log of the telemetry device 103, the NOC 101 issues a schedule read configuration request message to notify the device 103 that transmission of the requested data should follow a schedule specified in the request message (step 1105). In step 1107, the telemetry device 103 responds with a schedule read configuration acknowledgement message. Thereafter, the telemetry device 103 sends the requested data using one or more data messages, as in step 1109. FIGS. 12b-12d illustrate the format of the schedule read configuration request message and the data message. The scheduled read configuration sent to the telemetry device 103 is acknowledged by the telemetry by sending an acknowledgment message to the NOC 101.

FIG. 12a is a diagram of the formats of data logging messages used in the system of FIG. 1 for instructing the telemetry devices to collect certain data. A request message 1201 specifying the data logging configuration by which the telemetry device 103 stores information includes the following fields: an I/O Logging Select field 1201a for specifying the I/O data that is to be recorded and a GPS Logging Select field 1201b for indicating the GPS data that is to be recorded. In addition, the message 1201 includes a Schedule field 1201c that specifies the date and time as well as the interval between collection of the data (i.e., polling period).

FIG. 12b is a diagram of the format of a scheduled read configuration request message used in the system of FIG. 1 for retrieving data from the telemetry devices. The NOC 101 can instruct the telemetry device 103 to transmit data in from the data log to the NOC 101 according to a schedule through the issuance of a scheduled read configuration request message 1205. Additionally, this request message 1205 can activate and deactivate the schedule based on the status of inputs/outputs (I/O) 209, 211 of the telemetry device 103. The scheduled read configuration request message 1205 include the following fields: an I/O Select field 1203a for specifying the I/O data that is to be sampled, a GPS Select field 1203b for identifying the GPS data to be sampled, a Schedule field 1203c, an I/O Enable field 1203c. The Schedule field 1203c, as with the data logging configuration request message 1201, specifies a sampling interval (i.e., polling period). The polling period information permits the telemetry device 103 to determine the number of samples that is to be read before transmitting; for example, after reading one sample, transmit one sample, or after reading four samples, transmit four samples, etc. This allows the device 103 to batch messages, which is more efficient for the wireless network 107 because of reduced overhead.

The schedule (specified in the Schedule field 1203c) is enabled or disabled, as indicated by the I/O Enable field 1203d, according to the status of the I/O, such as vehicle ignition On/Off, seat occupancy, etc.

FIGS. 12c and 12d are diagrams of the format of a data message used in the system of FIG. 1. When reporting collected data in its data log, the telemetry device 103 utilizes a data message 1207, which includes a Number of Samples field 1207a to indicate the number of data samples reported in the message. An I/O Select field 1207b identifies the I/O data that has been sampled. A GPS Select field 1207c indicates the GPS data that is to be sampled. The data message 1207 contains the number of Samples (0 . . . n) 1207d specified by the Number of Samples field 1207a. Each Sample field 1207d contains data values associated with the particular I/O or GPS data. For example, a GPS sample 1207e provides information on the latitude, longitude, altitude, speed, and direction of the telemetry device 103, per the fields 1207f-1207j, respectively. Thus, the message 1207 states how many samples are in the message. Settings in the message 1207 indicate what data is included for each sample period, and all of the data (per the settings) for each sample period.

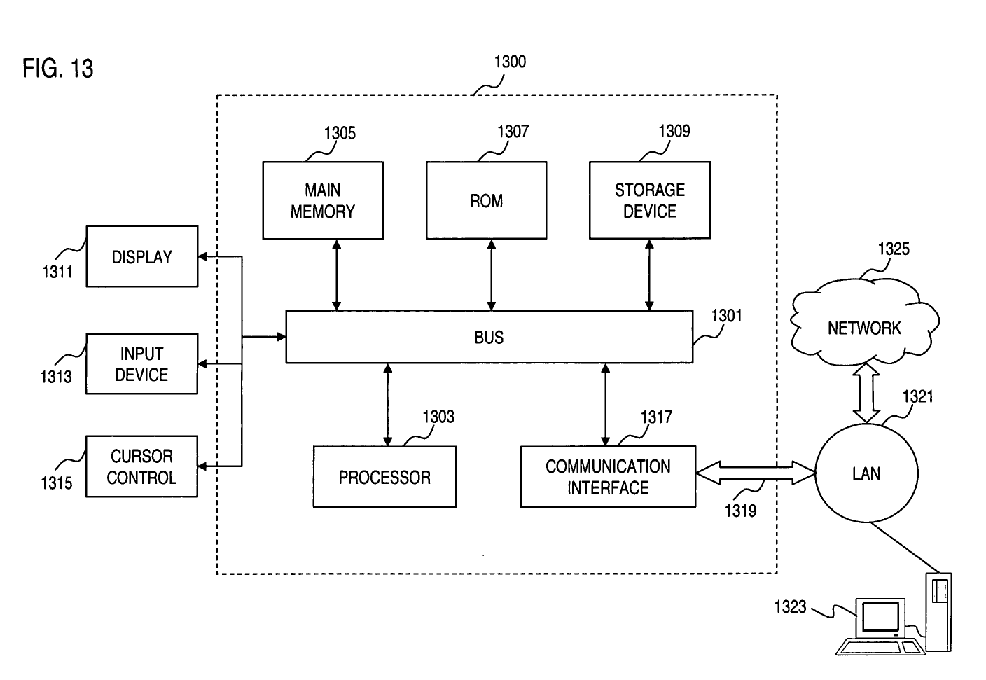

FIG. 13 illustrates a computer system 1300 upon which an embodiment according to the present invention can be implemented. For example, the client and server processes for supporting fleet and asset management can be implemented using the computer system 1300. The computer system 1300 includes a bus 1301 or other communication mechanism for communicating information and a processor 1303 coupled to the bus 1301 for processing information. The computer system 1300 also includes main memory 1305, such as a random access memory (RAM) or other dynamic storage device, coupled to the bus 1301 for storing information and instructions to be executed by the processor 1303. Main memory 1305 can also be used for storing temporary variables or other intermediate information during execution of instructions by the processor 1303. The computer system 1300 may further include a read only memory (ROM) 1307 or other static storage device coupled to the bus 1301 for storing static information and instructions for the processor 1303. A storage device 1309, such as a magnetic disk or optical disk, is coupled to the bus 1301 for persistently storing information and instructions.

The computer system 1300 may be coupled via the bus 1301 to a display 1311, such as a cathode ray tube (CRT), liquid crystal display, active matrix display, or plasma display, for displaying information to a computer user. An input device 1313, such as a keyboard including alphanumeric and other keys, is coupled to the bus 1301 for communicating information and command selections to the processor 1303. Another type of user input device is a cursor control 1315, such as a mouse, a trackball, or cursor direction keys, for communicating direction information and command selections to the processor 1303 and for controlling cursor movement on the display 1311.

According to one embodiment of the invention, the processes (e.g., processes of FIGS. 4 and 5) of the servers and clients in the system 130 of FIG. 1 are performed by the computer system 1300, in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement the embodiment of the present invention. Thus, embodiments of the present invention are not limited to any specific combination of hardware circuitry and software.

The computer system 1300 also includes a communication interface 1317 coupled to bus 1301. The communication interface 1317 provides a two-way data communication coupling to a network link 1319 connected to a local network 1321. For example, the communication interface 1317 may be a digital subscriber line (DSL) card or modem, an integrated services digital network (ISDN) card, a cable modem, a telephone modem, or any other communication interface to provide a data communication connection to a corresponding type of communication line. As another example, communication interface 1317 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1317 sends and receives electrical, electromagnetic, or optical signals that carry digital data streams representing various types of information. Further, the communication interface 1317 can include peripheral interface devices, such as a Universal Serial Bus (USB) interface, a PCMCIA (Personal Computer Memory Card International Association) interface, etc. Although a single communication interface 1317 is depicted in FIG. 13, multiple communication interfaces can also be employed.

The network link 1319 typically provides data communication through one or more networks to other data devices. For example, the network link 1319 may provide a connection through local network 1321 to a host computer 1323, which has connectivity to a network 1325 (e.g. a wide area network (WAN) or the global packet data communication network now commonly referred to as the “Internet”) or to data equipment operated by a service provider. The local network 1321 and the network 1325 both use electrical, electromagnetic, or optical signals to convey information and instructions. The signals through the various networks and the signals on the network link 1319 and through the communication interface 1317, which communicate digital data with the computer system 1300, are exemplary forms of carrier waves bearing the information and instructions.

The computer system 1300 can send messages and receive data, including program code, through the network(s), the network link 1319, and the communication interface 1317. In the Internet example, a server (not shown) might transmit requested code belonging to an application program for implementing an embodiment of the present invention through the network 1325, the local network 1321 and the communication interface 1317. The processor 1303 may execute the transmitted code while being received and/or store the code in the storage device 1309, or other non-volatile storage for later execution. In this manner, the computer system 1300 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1309. Volatile media include dynamic memory, such as main memory 1305. Transmission media include coaxial cables, copper wire and fiber optics, including the wires that comprise the bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

The following patent applications are incorporated in their entireties: co-pending U.S. patent application Ser. No. ______ (Attorney Docket No. 09710-1208) filed Jan. 16, 2004, entitled “Method and System for Tracking Mobile Telemetry Devices”; co-pending U.S. patent application Ser. No. ______ (Attorney Docket No. 09710-1209) filed Jan. 16, 2004, entitled “Method and System for Remotely Configuring Mobile Telemetry Devices”; co-pending U.S. patent application Ser. No. ______ (Attorney Docket No. 09710-1210) filed Jan. 16, 2004, entitled “Method and System for Mobile Telemetry Device Prioritized Messaging”; co-pending U.S. patent application Ser. No. ______ (Attorney Docket No. 09710-1211) filed Jan. 16, 2004, entitled “Method and System for Interfacing with Mobile Telemetry Devices”; co-pending U.S. patent application Ser. No. ______ (Attorney Docket No. 09710-1212) filed Jan. 16, 2004, entitled “Method and System for Transmitting Assistance Location Data for Fleet and Asset Management”; co-pending U.S. patent application Ser. No. ______ (Attorney Docket No. SKY-03-003) filed Jan. 16, 2004, entitled “Method and System for Tracked Device Location and Route Adherence via Geofencing”; and co-pending U.S. patent application Ser. No. ______ (Attorney Docket No. SKY-03-009) filed Jan. 16, 2004, entitled “Method and System for Secured Wireless Data Transmission to and from a Remote Device.”

While the present invention has been described in connection with a number of embodiments and implementations, the present invention is not so limited but covers various obvious modifications and equivalent arrangements, which fall within the purview of the appended claims.

1. A method for providing telemetry data, the method comprising:
receiving a telemetry data message from a telemetry device associated with a user;
determining location of a data repository for delivery of the telemetry data message, wherein the location is specified by the user; and
forwarding the telemetry data message to the data repository at the specified location.

2. A method according to claim 1, wherein the telemetry data message includes information on the location.

3. A method according to claim 1, further comprising:
mapping an identifier of the telemetry device with addressing information corresponding to the location.

4. A method according to claim 3, wherein the identifier is a serial number of the telemetry device, and the addressing information is either a Uniform Resource Locator (URL) or a Domain Name.

5. A method according to claim 1, further comprising:
receiving configuration information from the user, wherein the configuration information specifies format of the telemetry data message and the location.

6. A method according to claim 5, wherein the format is according to an extensible Markup Language (XML).

7. A method according to claim 1, further comprising:
receiving configuration information from the user; and
forwarding the configuration information to the telemetry device, wherein the configuration information specifies at least one of a type of telemetry data to be transmitted or an attribute of how the telemetry device is to generate telemetry data messages.

8. A method according to claim 7, wherein the attribute relates to when the telemetry device is to autonomously generate telemetry data messages.

9. A method according to claim 8, wherein the attribute relates to conditions under which the telemetry device is to autonomously generate the telemetry data messages.

10. A method according to claim 1, wherein the data repository is a file server.

11. A method according to claim 1, further comprising:
maintaining a data structure for associating the user with the location, associating the user with the telemetry device, or associating the telemetry device with the location.

12. A method according to claim 1, wherein the telemetry data message is received over a wireless network.

13. A method according to claim 1, wherein the telemetry device is mobile and configured to perform a position-determining function, the telemetry data message including position information pertaining to a geographical location of the telemetry device.

14. An apparatus for providing telemetry data, the apparatus comprising:
a communication interface configured to receive a telemetry data message from a telemetry device associated with a user; and
a processor coupled to the communication interface and configured to determine location of a data repository for delivery of the telemetry data message, wherein the location is specified by the user, the telemetry data message being forwarded to the data repository at the specified location.

15. An apparatus according to claim 14, wherein the telemetry data message includes information on the location.

16. An apparatus according to claim 14, wherein the processor is further configured to map an identifier of the telemetry device with addressing information corresponding to the location.

17. An apparatus according to claim 16, wherein the identifier is a serial number of the telemetry device, and the addressing information is either a Uniform Resource Locator (URL) or a Domain Name.

18. An apparatus according to claim 14, wherein the communication interface receives configuration information from the user, wherein the configuration information specifies format of the telemetry data message and the location.

19. An apparatus according to claim 18, wherein the format is according to an extensible Markup Language (XML).

20. An apparatus according to claim 14, wherein the communication interface receives configuration information from the user, the configuration information being forwarded to the telemetry device, wherein the configuration information specifies at least one of a type of telemetry data to be transmitted or an attribute of how the telemetry device is to generate telemetry data messages.

21. An apparatus according to claim 20, wherein the attribute relates to when the telemetry device is to autonomously generate telemetry data messages.

22. An apparatus according to claim 21, wherein the attribute relates to conditions under which the telemetry device is to autonomously generate the telemetry data messages.

23. An apparatus according to claim 14, wherein the data repository is a file server.

24. An apparatus according to claim 14, further comprising:
memory configured to store a data structure for associating the user with the location, associating the user with the telemetry device, or associating the telemetry device with the location.

25. An apparatus according to claim 14, wherein the telemetry data message is received over a wireless network including a two-way paging system.

26. An apparatus according to claim 14, wherein the telemetry device is mobile and configured to perform a position-determining function, the telemetry data message including position information pertaining to a geographical location of the telemetry device.

27. A computer-readable medium carrying one or more sequences of one or more instructions for providing telemetry data, the one or more sequences of one or more instructions including instructions which, when executed by one or more processors, cause the one or more processors to perform the steps of:
receiving a telemetry data message from a telemetry device associated with a user;
determining location of a data repository for delivery of the telemetry data message, wherein the location is specified by the user; and
forwarding the telemetry data message to the data repository at the specified location.

28. A computer-readable medium according to claim 27, wherein the telemetry data message includes information on the location.

29. A computer-readable medium according to claim 27, further including instructions for causing the one or more processors to perform the step of:
mapping an identifier of the telemetry device with addressing information corresponding to the location.

30. A computer-readable medium according to claim 29, wherein the identifier is a serial number of the telemetry device, and the addressing information is either a Uniform Resource Locator (URL) or a Domain Name.

31. A computer-readable medium according to claim 27, further including instructions for causing the one or more processors to perform the step of:
receiving configuration information from the user, wherein the configuration information specifies format of the telemetry data message and the location.

32. A computer-readable medium according to claim 31, wherein the format is according to an extensible Markup Language (XML).

33. A computer-readable medium according to claim 27, further including instructions for causing the one or more processors to perform the steps of:
receiving configuration information from the user; and
forwarding the configuration information to the telemetry device, wherein the configuration information specifies at least one of a type of telemetry data to be transmitted or an attribute of how the telemetry device is to generate telemetry data messages.

34. A computer-readable medium according to claim 33, wherein the attribute relates to when the telemetry device is to autonomously generate telemetry data messages.

35. A computer-readable medium according to claim 34, wherein the attribute relates to conditions under which the telemetry device is to autonomously generate the telemetry data messages.

36. A computer-readable medium according to claim 27, wherein the data repository is a file server.

37. A computer-readable medium according to claim 27, further including instructions for causing the one or more processors to perform the step of:
maintaining a data structure for associating the user with the location, associating the user with the telemetry device, or associating the telemetry device with the location.

38. A computer-readable medium according to claim 27, wherein the telemetry data message is received over a wireless network including a two-way paging system.

39. A computer-readable medium according to claim 27, wherein the telemetry device is mobile and configured to perform a position-determining function, the telemetry data message including position information pertaining to a geographical location of the telemetry device.

40. A method for providing a telemetry data from a remote telemetry device to a user, the method comprising:
receiving a first telemetry data message from the remote telemetry device;
determining location of a file server maintained by the user as being a destination for data from the remote telemetry device;
deriving a second telemetry data message from the first telemetry data message; and
sending the second telemetry data message to the file server location.

41. A method according to claim 40, wherein the step of determining the file server location is based upon an identifier in the first telemetry data message.

42. A method according to claim 40, wherein the second telemetry data message is in an extensible Markup Language (XML) format and comprises data from the first telemetry data message.

43. A method according to claim 40, further comprising:
receiving a communication from the user specifying the file server location; and
associating the file server location with the remote telemetry device.

44. A method according to claim 43, wherein the step of associating the file server location with the remote telemetry device comprises maintaining a data structure which performs at least one of:
associating the user with the file server location,
associating the user with the remote telemetry device, or
associating the remote telemetry device with the file server location.

45. A method according to claim 40, wherein the remote telemetry device communicates data messages over a wireless communications link.

46. A method according to claim 40, wherein the remote telemetry device comprises a position-determining function, and wherein the data message comprises position information pertaining to a geographical location of the remote telemetry device.

47. A method according to claim 40, further comprising:
receiving a communication from the user comprising configuration information for configuring an attribute of how the remote telemetry device is to generate telemetry data messages, wherein the configuration information specifies the location; and
sending the configuration information to the remote telemetry device.

48. A method according to claim 47, further comprising:
from the remote telemetry device, receiving a telemetry data message according to the configuring of the attribute of how the remote telemetry device is to generate telemetry data messages.

49. A method according to claim 47, wherein the attribute relates to when the remote telemetry device is to autonomously generate telemetry data messages.

50. A method according to claim 47, wherein the attribute relates to conditions under which the remote telemetry device is to autonomously generate telemetry data messages.
